(19) United States
(12) Patent Application Publication
(10) Pub. No.: US 2017/0066022 A1
(43) Pub. Date: Mar. 9, 2017

(54) METHODS FOR REMOVING TRAMP ELEMENTS FROM ALLOY SUBSTRATES

(71) Applicant: Siemens Energy, Inc., Orlando, FL (US)

(72) Inventors: Gerald J. Bruck, Titusville, FL (US); Ahmed Kamel, Orlando, FL (US)

(21) Appl. No.: 14/848,745

(22) Filed: Sep. 9, 2015

(51) Int. Cl. B08B 7/00; F01D 5/28; C23C 26/00

(52) U.S. Cl. CPC B08B 7/0014; C23C 26/00; F01D 5/288; F01D 5/286; F05D 2230/90; F05D 2230/30; F05D 2300/20; F05D 2300/121

(57) ABSTRACT

Methods are disclosed for cleaning a near surface region of an alloy substrate (10) in the presence of a flux material (12). A flux material is melted on the surface of the alloy substrate to a temperature sufficient to permit a reaction of the flux material with at least one tramp element present within the alloy substrate. The alloy substrate may remain solid, but diffusion of the tramp element is facilitated by an elevated temperature of the substrate. Fluxes disclosed may include a metal oxalate and/or other compounds capable of forming tramp element containing compounds by reaction with the alloy substrate to be cleaned, wherein the compounds formed have a ΔH_{f} lower than −100 kcal/g-mol at 25° C.

### FIELD OF THE INVENTION

This invention relates generally to the field of metallurgy, and more particularly to methods for cleaning alloys such that the alloys have low levels of tramp elements.

### BACKGROUND OF THE INVENTION

Alloy components such as blades and vanes used for high temperature gas turbine service are often formed of a substrate, such as a cast nickel based superalloy, coated with one or more coatings. Premature spallation of these coatings can occur when certain tramp elements diffuse from the substrate to the coating during operation of the component in a gas turbine engine.

Tramp elements are contaminants that are present in an alloy at relatively low concentrations, and for superalloys may include sulfur, phosphorous, lead, and bismuth, for example. All of these elements (and sometimes in combination with other superalloy constituents including silicon, carbon, oxygen and nitrogen) can be associated with solidification cracking (also known as hot cracking or liquation cracking) when, for instance, a substrate is cast, repaired or welded.

Perhaps the foremost problematic element for gas turbine superalloy applications is sulfur. Sulfur causes such cracking by way of the formation of low melting point eutectic phases (e.g. Ni₃S₂) at the last locations to solidify during casting or welding. Such low melting point material cannot sustain contraction stresses during solidification and, therefore, cracking results. Moreover, sulfur can cause spalling of a later-applied thermal or environmental barrier coating. Special measures must be taken to minimize sulfur contamination during casting and mold preparation as well as during weld repair operations.

Efforts have been made to remove sulfur from a substrate after it is cast, but prior to a coating process. For example, it is known that annealing the substrate in zirconia gettered hydrogen for 100 hours at 1200° C. removes sulfur and improves coating adherence in alloys such as PWA 1480 and PWA 1484. See Sariaglu, C., et al. in “The Control of Sulfur Content in Nickel-Based Single Crystal Superalloys and its Effects on Cyclic Oxidation Resistance, Superalloys pp. 71-80 (1996). The calculations of this study suggest, however, that adequate desulfurization at such temperature may require 492 hours of furnace annealing for materials of commercially significant thickness (e.g. 3 mm thick).

The same study mentions liquid phase desulfurization experiments in a vacuum induction furnace where the alloy was melted and the melt allowed to react with a reactive crucible lining of CaO (or Y₂O₃) (Sariaglu, et al. at p. 79). The reaction first appears to produce Ca_{(g)} which in turn reacts with sulfur in the melt to produce CaS. This specialized processing is expensive and further complicates the casting of alloys. For example, the substrate prior to melting might have been an alloy having a specific crystalline structure, such as being directionally solidified. Once melted, the substrate might not reform in precisely the same solid state structure. U.S. Pat. No. 5,922,148 to Irvine et al. disclosures a liquid state desulfurization process followed by directionally solidifying the melt to address this issue. Other liquid phase desulfurizations include U.S. Pat. No. 5,538,796 to Schaffer et al., which melts an article substrate at a temperature of at least 2000° C. for purpose of sulfur removal.

For alloy components that have already been cast and have been in-service, sulfur buildup (sulfidation) is also a problem. Sulfidation is a process whereby sulfur combines with the metal of the component over time. Alloy substrates used in turbine parts exposed to relatively low operating temperatures (below about 845° C.), are prone to sulfidation and must be cleaned or discarded as scrap once a certain quantity of sulfur deposit is formed on the component. Cleaning methods for removing sulfur deposits include fluorine ion cleaning (FIC), wherein fluoride gas (ex. hydrogen fluoride, HF) is injected into a reactor containing the parts to be cleaned and allowing fluorine to replace sulfur on the contaminated surfaces. Fluorides are then removed at high temperature in a vacuum chamber. FIC can cause intergranular attack in the material, which could lead to cracking and failure of components. Furthermore, fluorine ions remove not only sulfur, but also desired elements such as aluminum, which is commonly used in vanes/blades due to aluminum's ability to protect these components from oxidative damage.

Other methods for removing the tramp element sulfur are disclosed in U.S. Pat. No. 7,146,990 to Ngo et al. The methods include inserting a fluoride salt (as a solid) into an internal cavity of a turbine component and heating in an inert atmosphere. One problem with the use of an inert gas is the difficulty of maintaining complete inert gas shielding.

### BRIEF DESCRIPTION OF THE DRAWINGS

The invention is explained in the following description in view of the sole drawing that shows a method for removing tramp elements from an alloy substrate in accordance with an embodiment of the invention.

### DETAILED DESCRIPTION OF THE INVENTION

Fluxes are materials used as a protective covering for molten metal. In welding, a flux is a material used to prevent the formation of, or to dissolve and facilitate the removal of, oxides and other undesirable substances. Fluxes have been used in the context of laser welding wherein an alloy substrate is coated with an additive metal or metal alloy. For example, Patent Application Publication US 2015/0027993 A1 to the present inventors, incorporated herein by reference, discusses flux compositions for laser welding of superalloy materials.

The present inventors have now recognized that it is possible to use energy beams and fluxes to cleanse alloys of tramp elements without the presence of an additive or filler material. The inventors have also recognized that while such processes may remove tramp elements from only the near surface region of an alloy substrate, that result can be effective to prevent spallation of a later-applied coating. The inventors have recognized that certain fluxes are effective in removing such tramp elements from the near surface region of alloy substrates in a heat mediated process. Accordingly, the present inventors disclose processes that utilize flux to cleanse only a near surface region of an alloy substrate independent of coating the substrate with a filler material, bond coat, or ceramic thermal barrier coating, thereby avoiding the need for cleansing the full volume of the substrate material. The present invention utilizes existing additive manufacturing equipment in a cost effective manner to solve a problem that heretofore has required a more costly vacuum induction furnace, special fluorine ion cleaning equipment, or equipment for the control of an inert atmosphere.

Example embodiments include the removal of tramp elements of an alloy substrate (which may be a superalloy substrate) by applying heat for a duration and temperature sufficient to melt a flux material atop the substrate and to permit the reaction of the melted flux material with tramp elements in a region near the surface of the substrate. The processes disclosed may be used for new castings (after casting, but prior to coating) or for the cleaning of existing substrates which have been stripped of their coating for repair or servicing. The processes disclosed may also remove tramp elements without stripping the substrate of beneficial elements, such as aluminum.

As used herein, the terms “cleaning”, “cleansing,” and “remove tramp elements” are interchangeable. The term “alloy” may be a metal alloy, superalloy, chromium molybdenum alloys (also known as chrome moly, croalloy, chromalloy, and CrMo) which have been clad with nickel based alloys, stainless steels, or other metals or metal mixtures. These “alloys” may make up components such as blades or vanes of a gas turbine engine. As used herein the term “substrate” refers to an alloy or superalloy substrate or an alloy or superalloy gas turbine engine component which has not been coated with a thermal barrier or environmental coating or bond coat. The “substrate” may also refer to an alloy or superalloy gas turbine engine component for which has been stripped of its coating(s) for cleaning or repair.

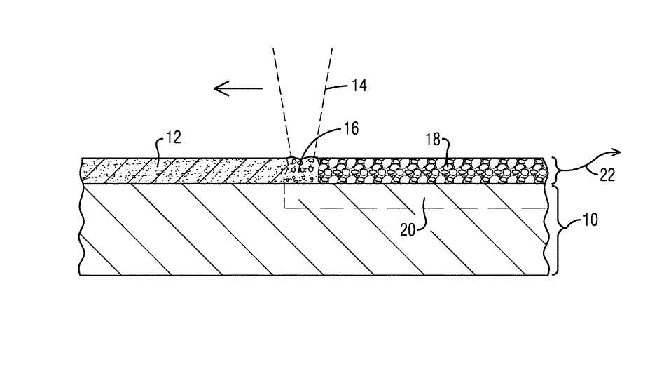

The processes disclosed may be performed in a number of ways. The embodiment of FIG. 1 depicts melting of the flux material 12, which has been placed on the surface of a substrate 10, by an energy beam 14 travelling along the length of the substrate 10. The energy beam 14 melts the flux material 12 to form a melt pool 16. The heat of the melted flux material, as well as energy of the beam passing through the flux material 12 and absorbed by the substrate 10, heats the underlying substrate 10 in near surface region or zone 20. This zone 20 is a region where tramp elements diffuse most rapidly toward the surface and the flux material. The near surface region 20 is heated to a temperature and for a time period sufficient for a tramp element present in the near surface region 20 to diffuse to the surface to react with the melted flux material in the melt pool 16 to form a reaction product. Reaction products may be solid or momentarily liquid state products (forming slag 18) or the products may be gaseous products, depending upon the tramp element(s) and the composition of the flux 12. If the products form a slag 18, the slag 18 blankets the substrate to provide an atmospheric shield and to retain elevated temperatures in the zone 20. Gas products formed also serve a shielding function. The disclosed methods therefore do not require the inert shielding gas of Ngo et al., cited above. The flux materials are considerably less expensive than large quantities of argon gas used in Ngo et al. Another advantage to the use of a flux is that a slag may be observed with the unaided human eye, giving visual confirmation to an operator that the substrate is blanketed, whereas a shielding gas might be colorless (argon is colorless).

Once the slag 18 has cooled, it is removed 22 to reveal the substrate having zone 20 depleted of tramp elements. In an embodiment, the substrate is cleansed to contain 5 ppm or fewer sulfur containing constituents in the near surface region 20. Further, the inventors have recognized that a near surface zone having a depth between as little as 15-30 micrometers is sufficient to protect a later-applied thermal barrier coating from spallation. This zone may also be 10 micrometers to 60 micrometers deep in other embodiments. This zone may also be 10 micrometers to 40 micrometers deep in other embodiments. U.S. Pat. No. 6,652,982 to Spitsberg, et al. teaches that a sulfur depleted zone of about 50 micrometers below the protective coating surface is optimal. Recognizing that a thinner region than deemed necessary in the prior art is all that is needed to be cleansed to provide protection for an overlying coating, the present inventors now disclose methods which permit the tramp elements to be removed without a full melt of the substrate. These methods are expected to be commercially viable due to their relatively low cost and rapid processing speed.

The energy beam 14 in the embodiment of FIG. 1 is a diode laser beam having a generally rectangular cross-sectional shape, although other known types of energy beams may be used, such as electron beam, plasma beam, one or more circular laser beams, a scanned laser beam (scanned one, two or three dimensionally), an integrated laser beam, etc. The rectangular shape may be particularly advantageous for embodiments having a relatively large area to be cleaned, such as for cleaning the tip of a gas turbine engine blade.

The substrate 10 may be heated to just below the melting point during the melting of the flux material 12 due to conduction heating as well as some absorption of beam energy by the substrate 10 itself. For example, if the substrate 10 has a melting point of around 1400° C., the flux material 12 may be melted and the underlying substrate heated to a temperature between 1200° C. and 1390° C.

The duration that the energy beam need be in contact with the flux material depends on a number of factors, for example, the temperature that the near surface region reaches, the concentration of tramp element that needs to be reduced, the thickness of the flux material that is deposited on the alloy and the intensity of the energy beam utilized. The energy beam may travel at a continuous velocity sufficient to melt the flux material in the path of the beam.

In some embodiments, the substrate is heated to near-melt. Because the substrate may be heated without undergoing a phase change, the process preserves the particular solid state structure of the substrate while at the same time increasing the rate of solid state diffusion of tramp elements within the substrate. Heating with an energy beam at the surface of the substrate increases the rate of diffusion of tramp elements such as sulfur at near surface portions of the substrate, where desulfurization is most needed. This is because heating with the energy beam as shown in FIG. 1 creates a temperature gradient throughout the substrate—the hottest portions being closer to the surface (such as zone 20), while the lower portions of the substrate remain cooler. While not as rapid as liquid state diffusion, the rate of solid state diffusion of tramp elements through the alloy is greatly increased when the alloy is heated to temperatures near the substrate's melting point because solid state diffusion rates increase with increasing temperature.

Methods disclosed also include at least partially melting the near surface region of the substrate. In one embodiment, up to 1 mm of the surface of the substrate adjacent the flux material is melted along with the flux material. In another embodiment, up to 2 mm of the substrate adjacent the flux material is melted along with the flux material. The rest of the substrate remains solid. This embodiment permits rapid comingling of the melted flux material with tramp elements present in this near surface melted region of the substrate as well as enhanced diffusion of tramp elements in the material just below the melted region, while at the same time preserving the particular solid state structure of the majority of the underlying substrate. Moreover, due to the insulative property of the slag 18, resolidification of any melted substrate material will occur primarily due to heat loss into the substrate 10, thereby facilitating grain growth from the substrate in the same form as existed prior to melting, such as directionally solidified in a direction perpendicular to the surface.

Finely powdered or melted flux may penetrate surface-opening cracks in a substrate to facilitate the cleaning of these hard to reach regions. Embodiments where a thin layer of the substrate is melted are particularly suitable for cleaning of crevices and cracks on the surface of a damaged substrate. Tramp elements trapped in a crack or crevice will flow into the alloy/flux melt pool, thereby facilitating their reaction with and removal by the flux. Depending upon the depth of the surface cracks, the entire crack may be eliminated by the melt, or a reformed cleansed region of the substrate may form over the crack, thereby sealing the crack and reducing the stress concentration at the crack tip. The resulting slag in any embodiment may be removed by a solvent bath or air blast or other mechanical means such as by brushing or chipping.

In both the solid and partial melt embodiments, the methods may also include a coating process wherein the cleaning process is followed by coating with a bond coat and/or a thermal barrier coating or environmental barrier coating.

In some embodiments, the flux materials include flux constituents which contain metals which form tramp element containing compounds (ex. phosphorous and sulfur) having an enthalpy of formation (ΔH_{f}) lower than −100 kcal/g·mol. Table 1 shows various tramp element containing compounds which are formed when a flux material is melted atop an alloy substrate in the presence of high heat:

TABLE 1

| | Products |
|---|---|
| | Formed/Standard heat of formation ΔH_{f} in |
| Flux Materials | kcal/g-mol |
| MnO, MnCO₃, MnC₂O₄ | MnS/−48.8; MnSO₄/−254.24; Mn₂(SO₄)₄/ |
| | −666.9; Mn₂(PO₄)₂/−771.0 |
| ZrO₂, ZrC | Zr(SO₄)₂/−597.4 |
| MgO, MgCO_{3,} | MgS/−83.0; MgSO₄/−305.5; Mg₃(PO₄)₂/ |
| | −961.5 |
| SiO₂, SiC | SiS₂/−34.7 |
| Al₂O₃, Al₄C₃ | Al₂S₃/−121.6; Al₂(SO₄)₃/−821.0 |
| Al₂(CO₃)₂ | Elemental Al - serves as Al replenisher; also |
| | Al₂S₃/−121.6; Al₂(SO₄)₃/−821.0 |
| CaO, CaF, CaC₂, CaCO₃, | CaS/−115.3; Ca₃P₂/−120.5 |
| CaC₂O₄ | Ca₃(PO₄)₂/−986.2 |

The mechanisms of reactions that occur when certain chemicals are irradiated by an energy beam, such as a laser, are not yet fully understood. However, all of the flux constituents listed in Table 1 (except silica compounds) are capable of reducing sulfur and/or phosphorous with enthalpies of formation values lower than −100 kcal/g·mol. The lower the enthalpy of formation, the more favored a reaction is to form that substance because the resulting product is thermodynamically more stable. Enthalpy of formation values vary slightly based on temperature and are calculable values. Standard values (derived at 25° C.) serve as indicators of thermodynamically favored products at temperatures near the melting temperatures of common metals and superalloys because of the relatively small difference in enthalpy of formation values at standard conditions and their calculated values at various nonstandard temperatures contemplated herein. For this reason, the flux materials comprising metals which combine to form tramp element containing compounds with largely negative enthalpies of formation are of particular interest. Manganese and aluminum bearing flux constituents forming Mn₂(SO₄)₄ and Al₂(SO₄)₃ are particularly noteworthy. Manganese, magnesium and calcium bearing flux constituents forming Mn₂(PO₄)₂, Mg₃(PO₄)₂ and Ca₃(PO₄)₂ are particularly noteworthy.

In some embodiments, the flux material may include a metal carbonate, metal oxide, or both. The flux material may also include a metal oxalate. The flux material may also include a metal carbide and/or a metal halide. The flux material may also include the flux compositions described in Patent Application Publication US 2015/0027993 A1, incorporated above by reference. In some embodiments, the flux materials of the present disclosure include at least one aluminum bearing compound constituent.

The inclusion of the oxalate compounds may, upon interaction with the energy beam of FIG. 1, supply intermediate compounds (e.g. hydrogen peroxide, H₂O₂) that assist in the oxidation of the sulfur of the Ni₃S₂ to its S(VI) state (the oxidation state of sulfur in sulfates). As a side note, H₂O₂ is also reactive with malodorous sulfide gases to form elemental sulfur and water, thereby acting as an odor reducer in the event these gases are formed during laser melting. Concentrations of the oxalate compound are relatively low in embodiments, between 1-10% by weight of the flux material as a whole, with other flux materials making up the remainder. Further, embodiments include exposing the substrate to such oxidizing agents for no more than two minutes.

In addition to the flux reacting with tramp elements for the purpose of segregating the tramp elements as slag, off-gas, or both, the flux may also serve to add elemental aluminum to the substrate. Compensation for aluminum loss may be necessary because laser heating may cause removal of aluminum from the substrate or because prior operation of the material in a gas turbine environment resulted in such loss. Loss of aluminum may be problematic for some superalloys because aluminum is critical to the strength and oxidation resistance of such materials. Embodiments of the present invention include fluxes containing aluminum in the form of aluminum carbonate Al₂(CO₃)₃, as described in Patent Application Publication US 2015/0027993 A1. Aluminum carbonate is unstable and under certain conditions can decompose to produce carbon dioxide CO₂ and aluminum hydroxide Al(OH)₃. The present inventors have realized that when used in a flux for laser processing, aluminum carbonate will dissociate due to laser interaction, and will generate elemental aluminum along with carbon monoxide and carbon dioxide at the location of dissociation. Advantageously, the elemental aluminum is thus made available to compensate for the above-described loss of deposited aluminum, and the gasses prevent the oxidation of the elemental aluminum and provide overall shielding of the molten metal from atmospheric oxidation and nitridation.

While various embodiments of the present invention have been shown and described herein, it will be obvious that such embodiments are provided by way of example only. Numerous variations, changes and substitutions may be made without departing from the invention herein. For example, while the use of the energy beam for melting the flux has been described in relation to FIG. 1 above, other methods for melting the flux may be used. For instance, melting may take place by arc melting, plasma melting, or induction heating of the substrate to melt the flux overburden. Also, although less energy is required to heat a portion of a substrate with an energy beam than is required to heat an entire substrate, for instance by heating or melting in a furnace (Sariaglu et al.), a furnace may still be used as an embodiment method. If the furnace melting method is used, the process would be useful for cleaning components having internal cavities which could be filled with flux material but may not be reached by an energy beam. The flux materials would be heated until it reaches a temperature sufficient to cause constituents in the flux materials to react with tramp elements diffusing to the surfaces of the substrate so as to form a slag, or gas, or both. As with other methods, the slag or gas or both may be removed by a solvent bath or air blast, or other means known in the art for removing a slag or gas or both.

The process may be used on both high temperature superalloy substrates, or alloy substrates used in turbine parts having relatively low operating temperatures (below about 845 C), as these are prone to sulfidation (sulfur combining with the metal of the substrate).

Accordingly, it is intended that the invention be limited only by the spirit and scope of the appended claims.

The invention claimed is:

1. A method comprising:
depositing a flux material on a surface of an alloy substrate;
melting the flux material and heating a near surface region of the alloy substrate independent of any coating process to permit a reaction of the flux material with a tramp element from within the near surface region to form a reaction product; and
removing the reaction product from the near surface region.

2. The method of claim 1, wherein the alloy substrate below the melted flux material remains solid.

3. The method of claim 1, wherein the near surface region is between only 10 and 40 micrometers deep.

4. The method of claim 1, wherein the flux material comprises aluminum or an aluminum containing compound.

5. The method of claim 1, wherein the flux material comprises a constituent which forms a reaction product compound with a ΔH_{f} lower than −100 kcal/g-mol at 25° C.

6. The method of claim 1, wherein the flux material comprises a metal oxalate.

7. The method of claim 1, wherein the flux material comprises
aluminum carbonate; and
at least one of the group of a metal oxide, a non-aluminum metal carbonate, a metal halide, a metalloid oxide, and a metal carbide.

8. The method of claim 1, further comprising:
cleaning the surface of the substrate of any unmelted flux material and slag; and
applying a coating to the surface.

9. The method of claim 8, wherein the coating is a bond coat.

10. The method of claim 9, further comprising depositing a ceramic thermal barrier coating onto the bond coat.

11. The method of claim 1, wherein a portion of the near surface region of the substrate below the melted flux is melted during the melting step.

12. The method of claim 1, further comprising:
the flux material is deposited onto a portion of the substrate surface containing a surface opening crack; and
melting a portion of the near surface region of the substrate containing the surface opening crack during the melting step;
wherein a contaminant within the surface opening crack reacts with the flux material to contribute to the reaction product.

13. A method comprising:
cleaning a near surface region of an alloy substrate of a tramp element in the presence of a flux material, the cleaning further comprising the steps of:
depositing the flux material onto a surface of the alloy substrate;
heating the flux material sufficiently to melt the flux material and heating the near surface region of the alloy substrate to a temperature below a melting temperature of the alloy substrate for a time sufficient for the tramp element to diffuse to the surface and to react with the melted flux material to form a reaction product; and
removing the reaction product to reveal a cleaned surface.

14. The method of claim 13, further comprising depositing a coating on the cleaned surface.

15. The method of claim 14, wherein the coating is a bond coat.

16. The method of claim 15, further comprising depositing a ceramic thermal barrier coating over the bond coat.

17. The method of claim 13, wherein the flux material comprises a metal oxalate.

18. The method of claim 13, wherein the flux material comprises
an aluminum carbonate; and
at least one of the group of a metal oxide, a non-aluminum metal carbonate, a metal halide, a metalloid oxide, and a metal carbide.

19. The method of claim 13, wherein the near surface region is between 10 and 40 micrometers deep.

20. The method of claim 13, wherein the flux material comprises a constituent which reacts with the tramp element to form a reaction product having a ΔH_{f} lower than −100 kcal/g-mol at 25° C.
